(19) United States
(12) Patent Application Publication
(10) Pub. No.: US 2015/0030211 A1
(43) Pub. Date: Jan. 29, 2015

(54) METHOD OF IDENTIFYING A PERSON

(71) Applicant: Yakov Z. Mermelstein, Spring Valley, NY (US)

(72) Inventor: Yakov Z. Mermelstein, Spring Valley, NY (US)

(21) Appl. No.: 13/949,559

(22) Filed: Jul. 24, 2013

(51) Int. Cl. G06K 9/00

(52) U.S. Cl. CPC G06K 9/00892
USPC 382/115

(57) ABSTRACT

The Invention involves a person being able to quickly access the electronic profile of another person. When a person wants someone to receive his profile (or a portion of the profile), he obtains the electronic address of that person. Then the pertinent information from the profile is sent in real time to that electronic address. Another embodiment involves a person providing an electronic identifier to a second person, and that electronic identifier is then used by him to access the profile.

### FIELD OF THE INVENTION

This invention relates to the electronics and communications industry and, more particularly, to a method of electronically identifying a person.

### BACKGROUND OF THE INVENTION

With all of the modern technology, there is still the uncomfortable situation of someone ringing your doorbell and you do not know who it is. It is possible to check a photo identification, but these id cards could be stolen or forged.

Even when a person's identify can be confirmed, there still is the need to have some biographic or other information about the person.

Therefore, there is a need in the industry for a more reliable procedure for checking someone's identity and/or to obtain information about him.

### SUMMARY OF THE INVENTION

These and other objects of the invention are achieved with a method for electronically identifying a person.

According to the Invention, in its simplest, basic form, it involves a person being able to quickly access the electronic profile of another person. When a person wants someone to receive his profile (or a portion of the profile), he obtains the electronic address of that person. Then the pertinent information from the profile is sent in real time to that electronic address.

Another embodiment involves a person providing an electronic identifier to a second person, and that electronic identifier is then used by him to access the profile.

In the preferred embodiment, the method of identifying a person includes: creating a file of information of a first person and storing it in a universally accessible electronic location; identifying a location of the first person; the file of information containing said location of the first person; the first person receiving an electronic address of a second person; and sending selected information from the file of information of the first person to the electronic address of the second person.

Other objects, features and advantages of the present invention will become apparent upon reading the following detailed description in conjunction with the drawings and the claims.

### BRIEF DESCRIPTION OF THE DRAWINGS

For a better understanding of the invention, its operation and specific objects attained by its uses, reference should be had to accompanying drawings and descriptive matter in which there are illustrated preferred embodiments of the invention.

The invention will now be described in connection with certain preferred embodiments with reference to the following illustrative figures so that it may be more fully understood.

FIGS. 1-3 are flow charts, showing the process of the invention.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

For purposes of the invention, the term portable electronic device includes any portable device that may be used for electronic communication, including, but not limited to, mobile devices, cell phones, smart phones, hand held computers, laptop computers, palm top computers, personal digital assistant (PDA), electronic pads and/or tablets.

The term Global Positioning System should also include any communication system that helps the device determine location, and it is not limited to and may include “WIFI,” “Bluetooth,” “NFC” and/or “GPS.” Herein after the term GPS is being used to include all these applicable protocols for global positioning.

According to the Invention, in its simplest, basic form, it involves a person being able to quickly access the electronic profile of another person.

This profile necessarily includes all identifying and contact information of the person. In other words, it has his contact profile. Instead of the card being physical, it is stored either in an Internet cloud or in a web server.

Preferably the profile includes a picture of the person and an electronic identifier (i.e. a PIN number) and also his geographic location.

The type of information that may be stored in this profile (the file of information) is unlimited. It may be simple biographic information, like phone, e mail, address, birthday etc. Photos may be included. His current GPS location can be included. Audio and/or audio/video materials may be stored. Business affiliations can be included. Credit card, bank details and financial information can also be included.

According to the invention, when a person wants someone to receive his profile (or a portion of the profile), he obtains the electronic address of that person. Then the pertinent information from the profile is sent in real time to that electronic address. Another embodiment involves a person providing an electronic identifier to a second person, and that electronic identifier is then used by him to access the profile

More specifically, if a person comes to someone's home or to an office, he obtains the electronic address of that person or office. Then pertinent information from the profile can be instantly sent in real time to that electronic address. In this manner the person in the home or office can see the pertinent details of the person who has just arrived.

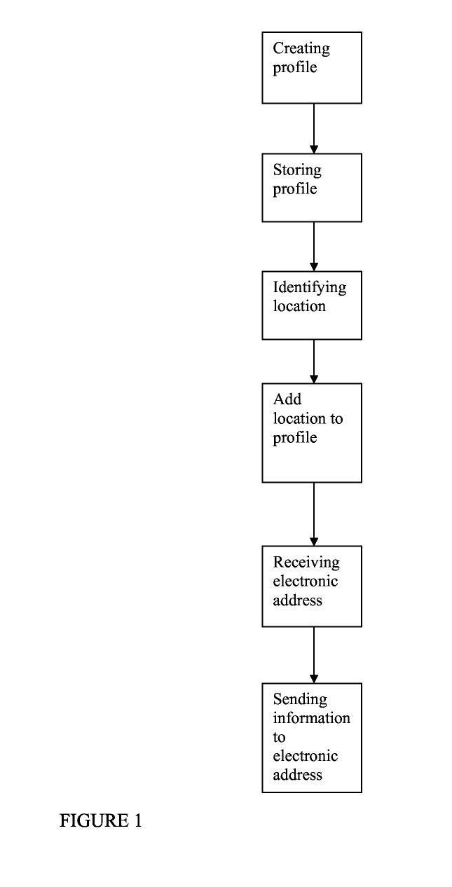

In the preferred embodiment of the invention (FIG. 1), the method of identifying a person includes: creating a file of information of a first person and storing it in a universally accessible electronic location; identifying a location of the first person; the file of information containing said location of the first person; the first person receiving an electronic address of a second person; and sending selected information from the file of information of the first person to the electronic address of the second person.

By means of GPS, the location of a person is easily determined by determining the location of his portable electronic device. Nowadays most portable electronic devices, especially smart phones and IPads, have build GPS capability. Then, this location information is inserted into the profile.

Hence, according to the method, identifying the location of said first person includes using GPS to determine a physical location of a portable electronic device of the first person and embedding the location information in the file of information.

Since the profile includes the current GPS location, it allows different options.

For example, when the selected information is sent, it can include the location information. In this way the recipient can easily determine if the person in front of him is the right person—the locations will match. Another way is to just indicate whether or not the person is at a specified location (like at the second person's home or office). For security reason, instead of giving the location, the profile will just indicate he is not at a specified location.

More particularly the location information in the profile will show the current location or it can just indicate he is at another location.

According to the method, the selected information from the file of information can contain the location of the first person. In another embodiment, it may just indicate whether or not the first person is at a specified location.

This electronic address of the second person can be for any electronic means for viewing data. For example, it can use application programming interface (API) to direct the information into any kind of file, existing on a cloud, a server or a network, from which is can be read and/or accessed. He may also use a portable electronic device, like a smart phone or Ipad, to view the material.

By the term “file of information” is meant the person's profile, as described above. Any type of information can be included in this profile.

Upon reaching a destination or an office or meeting another person, the first person obtains the electronic address of that person (or business or office) that he wants to have his information. This can be done in any number of known manners. One particular way is to use the scanning capabilities in your smart phone and to scan a bar code. It may also be done using WIFI,” “Bluetooth,” or “NFC” technology.

According to the herein method, providing access to the electronic identifier includes an electronic reader, a bar code and/or “WIFI,” “Bluetooth,” and/or “NFC.”

Thereafter, the person selects the particular relevant information in his profile. It is then sent in real time to the electronic address of the intended recipient. In this way he can pop open the pertinent portion of the profile on his smart phone or IPAD etc or even in a file on a cloud. This allows him to obtain information about the person.

For example, if a meter reader from a gas or electric company comes to a house, people may not know who he is and may be reluctant to let him in. So, the meter reader uses his smart phone to scan a bar code and he obtains the electronic address of the home owner. The home owner then instantly receives on their smart phone (or other portable electronic device) pertinent details about the meter reader. In this way, he can verify that he is in fact the meter reader.

Seeing the profile also allows the person to just decide he does not want to see the person. For example, it could be a travelling salesman or an insurance agent or an annoying neighbor.

Security is important. You want to know a person is who he says he is. Therefore the profile can include details to help ensure the identity of the person.

In one embodiment, the file of information of the first person can specify locations of that person for specified times and the selected information from the file of information can include these locations of that person for the specified times. By this means, the recipient can see if the person is where he is supposed to be.

For example, consider again the case of a meter reader. His profile may indicate that on Monday from 10 am until 11 am he is supposed to be checking houses on Washington Street. Instead he is on Lincoln Street (a kilometer away from Washington) at these times. This should alert the recipient or homeowner that something is not right. Before letting in the meter reader, he can check with the utility company. If his home is on the street where the meter reader is supposed to be at that time, then the home owner has more confidence he is dealing with a legitimate meter reader.

According to the method, the file of information of the first person can specify a status of the person for specified times and the selected information from the file of information may include the status of the person for specified times.

In other words, the profile may indicate that from 12 until 1 the person is at lunch. It may indicate that on Monday he is taking a personal day and not working. Considering again the example of the meter reader, when the recipient receives the profile it may indicate that the person is at lunch or taking a personal day. Here again it should alert the home owner and he can check with the utility company. If the status is that the meter reader is out reading meters, then the home owner knows it is okay to allow entry for reading the meter.

According to another aspect of the invention, the recipient may want to take some action when he obtains the person's profile.

The method further includes the second person activating an electrical apparatus. Generally, the electrical apparatus may be anything and may typically include, without limitation, lighting, a door, a gate, an elevator, a surveillance system, an alarm, and/or a monitoring system.

If the home owner or business verifies the person's identity, they can electronically open a door or gate and/or turn on a light. Music can be activated if waiting is involved. Even elevators could be activated to take the person to the designated floor.

In appropriate situations, there may be activation of lighting, a surveillance system, an alarm, and/or a monitoring system.

Another way to promote security is to include the person's picture in the profile. This allows the recipient of the profile to visually check to see that the person matches the picture. If not, then the police or other appropriate authorities can be called. Entry can obviously be barred.

In another preferred embodiment for enhanced security, a PIN number or electronic identifier can be used.

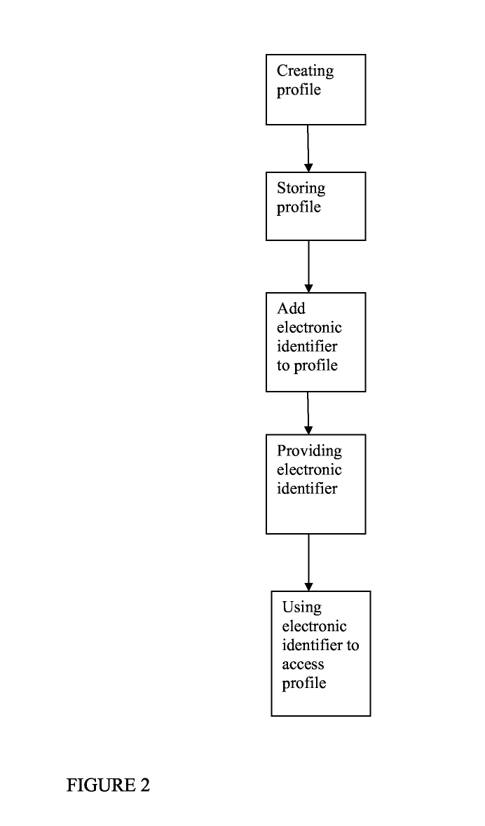

Accordingly (FIG. 2), a method of identifying a person includes: creating a file of information of a first person and storing it in a universally accessible electronic location, the file of information including an electronic identifier of said first person; the first person providing access to said electronic identifier to a second person so that this second person can have access to selected portions of the file of information; and by means of the electronic identifier, the second person accesses the selected portions of the file of information of the first person.

In this embodiment, each profile would include a unique electronic identifier—like a PIN number. The home owner or office or other person obtains the electronic identifier and can thus access the profile.

According to one aspect of this embodiment, the electronic identifier may include any type of technology for identifying an individual, based on personal characteristics. As technology has advanced, many new type of identification have been created, including, without limitation, finger print, palm print, Iris/Eye scans, Facial Recognition scans, Vocal Recognition, and as well as many other technologies.

Therefore, the way of sending or providing information to anyone/entity may be by Fingerprint or palm print.

Fingerprint and palm print recognition is a known technology. Some countries, for example Israel, use palm print recognition to identify travelers instead of having the traveler wait in line for a live person to examine the passport.

For example, in this embodiment, there will be a “scanner” machine. Wherever and whenever someone wants to transmit some or all of his profile, he can scan his finger/palm and the scanned print is sent to a central depository. At this depository, a central database includes the finger/palm and verifies the identity of the person. If there is verification, then all or a certain portion of the profile of that person is sent. In some cases, this may include the location of that person.

It can also be used at stores so that after scanning and verification, the store will get access to the profile and be able to send the invoice to the customer's portable device to approve and then send back the receipt. All this gets done in real time instantly while the customer is at the sales counter.

This approach is different from what is currently being done when obtaining finger or palm prints. Many companies and also governments use fingerprints and/or palm prints, but for their own purpose. It is used as an identifier, but not as a means of sending information. According to the invention herein, however, there is a personal database of information for everyone. Thus, when there is a scanning your finger/palm print, it goes in real time to the central station for verification and transmission of all or part of your profile.

According to the method, providing access to the electronic identifier includes an electronic reader, a bar code and/or “WIFI,” “Bluetooth,” and/or “NFC.”

This would cover the situation where someone meets another person and wants him to be able to see selected portions of his profile. So, he gives him the PIN (i.e. electronic identifier). Then the recipient at his convenience can call up the profile and see the desired information.

For convenience people may include this PIN on their business cards. In this way they can more efficiently provide people with their pertinent details.

Instead of referring to a public website, it points to a private profile.

Another embodiment is advantageous when a person goes into a place and has to normally take a number and wait his turn. This can happen at a government office, a utility, a doctor's office or any number of places. In daily life it is always happening.

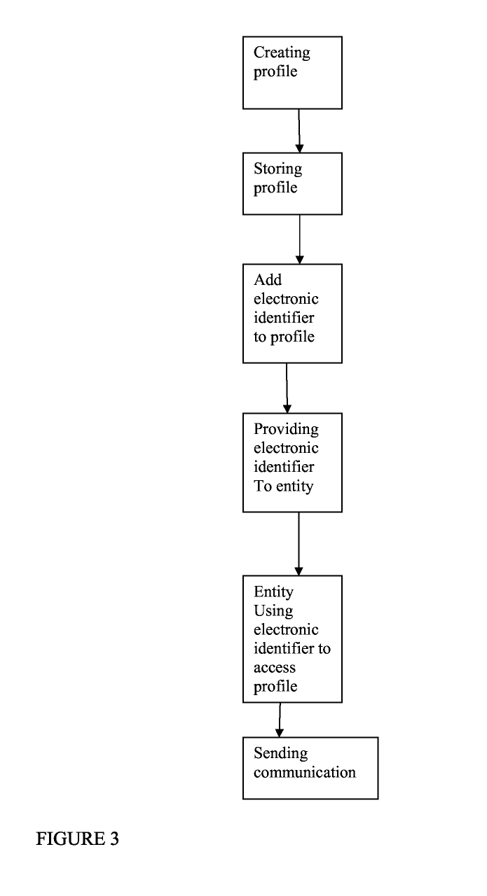

According to this embodiment (FIG. 3), a method of facilitating meeting representatives of an entity includes: creating a file of information of a person and storing it in a universally accessible electronic location, the file of information including an electronic identifier; the person transmitting the electronic identifier to an entity; by means of this electronic identifier, the entity accesses the file of information of the person; and the entity sends a communication to said first person via a portable electronic device of the person to identify when a representative of the entity will be available to meet the person. Transmitting the electronic identifier includes an electronic reader, a bar code and/or “WIFI,” “Bluetooth,” and/or “NFC.”

In this embodiment, the profile is created as heretofore mentioned. When a person enters an office he simply scans his smart phone (or other portable electronic device) or uses “WIFI,” “Bluetooth,” and/or “NFC” technology. His personal electronic identifier (i.e. a PIN Number) is now in the queue for the office. Two things now happen. Using the electronic identifier, the profile is accessed so the representative of the entity has all the necessary details of the visiting person. In addition, the entity periodically sends messages to the person to tell him when the representative will be able to see him These messages can be SMS or twitters or e mails or any reasonable electronic communication. Instead of looking at the office screen to watch the countdown to his number, the person gets regularly updated on his smart phone. This allows him to go for a walk and handle other errands while he is waiting.

It will be evident to those skilled in the art that the invention is not limited to the details of the foregoing illustrative embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

I claim:

1. A method of identifying a person comprising:
A. Creating a file of information of a first person and storing it in a universally accessible electronic location;
B. Identifying a location of said first person;
C. Said file of information containing said location of said first person;
D. Said first person receiving an electronic address of a second person; and
E. Sending selected information from said file of information of said first person to said electronic address of said second person.

2. A method according to claim 1, further comprising said selected information from said file of information containing said location of said first person.

3. A method according to claim 1, further comprising said selected information from said file of information indicating whether or not said first person is at a specified location.

4. A method according to claim 1, wherein Identifying said location of said first person includes using GPS to determine a physical location of a portable electronic device of said first person and embedding said location information in said file of information.

5. A method according to claim 1, wherein said file of information of said first person specifying locations of said person for specified times and said selected information from said file of information including said locations of said person for specified times.

6. A method according to claim 1, wherein said file of information of said first person specifying a status of said person for specified times and said selected information from said file of information including said status of said person for specified times.

7. A method according to claim 1, further comprising said second person activating an electrical apparatus.

8. A method according to claim 7, wherein said electrical apparatus includes lighting, a door, a gate, an elevator, a surveillance system, an alarm, and/or a monitoring system.

9. A method according to claim 1, wherein said file of information of said first person includes a photograph of said first person and said selected information from said file of information includes said photograph of said first person.

10. A method according to claim 1, wherein said receiving said electronic address of said second person includes an electronic reader, a bar code and/or “WIFI,” “Bluetooth,” and/or “NFC.”

11. A method according to claim 1, further comprising:
A. Said file of information including an electronic identifier of said first person; and
B. By means of said electronic identifier, said second person accessing said file of information of said first person.

12. A method according to claim 11, wherein said electronic identifier including means for identifying individuals based on personal characteristics.

13. A method according to claim 11, wherein said electronic identifier being selected from the group comprising finger print, palm print, Iris/Eye scans, Facial Recognition scans, Vocal Recognition.

14. A method of identifying a person comprising:
A. Creating a file of information of a first person and storing it in a universally accessible electronic location, said file of information including an electronic identifier of said first person;
B. Said first person providing access to said electronic identifier to a second person so that said second person can have access to selected portions of said file of information; and
C. By means of said electronic identifier, said second person accessing said selected portions of said file of information of said first person.

15. A method according to claim 13, further comprising identifying a location of said first person and said file of information containing said location of said first person.

16. A method according to claim 13, wherein said providing access to said electronic identifier includes an electronic reader, a bar code and/or “WIFI,” “Bluetooth,” and/or “NFC.”

17. A method of facilitating meeting representatives of an entity comprising:
A. Creating a file of information of a person and storing it in a universally accessible electronic location, said file of information including an electronic identifier;
B. Said person transmitting said electronic identifier to an entity;
C. By means of said electronic identifier, said entity accessing said file of information of said person; and
D. Said entity sending communications to said person via said portable electronic device of said person to identify when a representative of said entity will be available to meet said person.

18. A method according to claim 16, wherein said transmitting said electronic identifier includes an electronic reader, a bar code and/or “WIFI,” “Bluetooth,” and/or “NFC.”
